(19) United States
(12) Patent Application Publication
(10) Pub. No.: US 2003/0091831 A1
(43) Pub. Date: May 15, 2003

(54) Seamless animal floor system

(76) Inventor: Mark E. Mickey, Caldwell, OH (US)

Correspondence Address: MCKAY & ASSOCIATES, PC., 801 MCNEILLY ROAD, PITTSBURG, PA, 15226, US

(21) Appl. No.: 09/992,963

(22) Filed: Nov. 6, 2001

(51) Int. Cl. B32B 27/00

(52) U.S. Cl. 428/423.1

(57) ABSTRACT

A seamless floor system in an animal handling area is disclosed. A base composition covers a surface of the animal handling area. At least one coating mixture covers the base composition, wherein the coating mixture is a mixture of granulated rubber and urethane containing in part the urethane in the range of 7%-25%. At least one sealer covers the coating mixture. Thus, a seamless, rubber alley, stall, or milking parlor is formed as part of the animal handling area.

### BACKGROUND

The present invention relates to poured-in-place rubber floor surfaces and methods of application therefor. In particular, a seamless rubber turf product is disclosed and used in conjunction with animal handling areas for improving the comfort of animal stalls, alleys, and/or milking parlors for cattle.

Most farm animals that are not kept in natural outdoor field settings are kept in indoor stalls or barn pens. Traditionally, these indoor holding facilities are very low comfort areas, which have animal handling areas typically comprised of a cement or concrete surface covered with straw. These and other bedding materials used in conjunction with concrete pens may be very expensive and the cost and effort put forth in maintaining the areas is also very excessive.

Stressful to the animals and irritating to the bony protrusions of cows, for example, typical animal holding stall surfaces do not encourage adequate rest. Recent studies have shown that comfortable pens encourage more resting time for cows. In fact, dairy cows kept on softer flooring stand up and lay down almost twice as often as cows kept on concrete surfaces. This action has been associated with greater milk production because when cows lay down, blood flow to the udder and rumination increases. See abstract from Dairy Housing and Equipment Systems: Managing and Planning for Profitability.

Seamless rubber flooring surfaces are generally known in the art to accommodate individuals involved in sporting events and athletic activities. U.S. Pat. No. 6,200,638 to Ordway, for example, teaches a mixture of rubber and urethane binders for stable floor surfaces such as gyms, basketball courts, volleyball courts, pool decks, and the like. U.S. Pat. No. 5,183,438 to Blom demonstrates a general-purpose sports floor installed on a supporting substructure. U.S. Pat. No. 5,605,721 to Di Geronimo is directed to an underlayment composition for an artificial playing surface comprised of butadiene rubber.

There is a need then for a high-comfort floor system that is adapted to accommodate animals such as horses or cows. To accomplish this, the properties of the surface of an animal handling area must be accounted for. Typical containment areas include stalls, alleys, and parlors and the present invention addresses the different degrees of softness and sanitation required for covering the surface of each area, thereby increasing the comfort and maintenance efficiency for animal holding pens.

### SUMMARY OF THE INVENTION

The objective of the present invention is to provide a high-comfort seamless floor system for animals, which is easily kept sanitary, decreases the long-term costs of bedding materials, and reduces maintenance time and labor costs. The seamless floor system provides for multiple comfort areas where horses and dairy cows, for example, may lie down, be handled, or be milked thereon as an alternative to rough and abrasive floor conditions.

Accordingly, what is provided is a seamless floor system, comprising an animal handling area surface substituted with a base composition, at least one coating mixture covering the base composition, and at least one sealer applied to the coating mixture, wherein the animal handling area surface is a surface selected from the group consisting of asphalt, concrete, stone, sand, mulch, sawdust, composted manure, straw, wood chips, ground limestone, shredded newspaper, cornstalks, bark, peanut hulls, sunflower hulls, and rice hulls. At least one of the animal handling area surfaces above is modified to allow the formation of the base composition to generally be finished concrete, finished asphalt, or finished aggregate. The coating mixture is a two-part mixture of granulated rubber and a polyurethane binder, and the sealer is a thixotropic mixture of an amine blend and diisocyanate pre-polymer. The number and thickness ranges of the coating mixtures and sealers is dependent upon whether the system is to be implemented for the production of a surface for an alley, parlor, or stall. Two layers of the sealer are applied to effectively sanitize a milking parlor area, and in another instance, two layers of the coating mixture, each a sub coat and top coat, are used in the production of a free stall surface system to achieve different degrees of softness.

### BRIEF DESCRIPTION OF THE DRAWINGS

FIG. 1 is a cross-sectional representation of the free-stall system.

FIG. 2 is a cross-sectional representation of the alley system.

FIG. 3 is a cross-sectional representation of the parlor system.

### DETAILED DESCRIPTION OF THE PREFERRED EMBODIMENT

The present invention is directed to a seamless, animal floor and surfacing system for the purposes of accommodating animals such as cows and horses. Interior and/or exterior holding development structures for animals vary according to function. A free stall as termed herein is an area located in the holding developments where cows, for example, may lie down out of high traffic areas. An alley as termed herein is an area surrounding the free stalls and any feed rails, which allows the free movement of the animals as they walk to different pen areas such as feeding alleys or milking parlors. The milking parlor as termed herein is an area wherein dairy cows are milked.

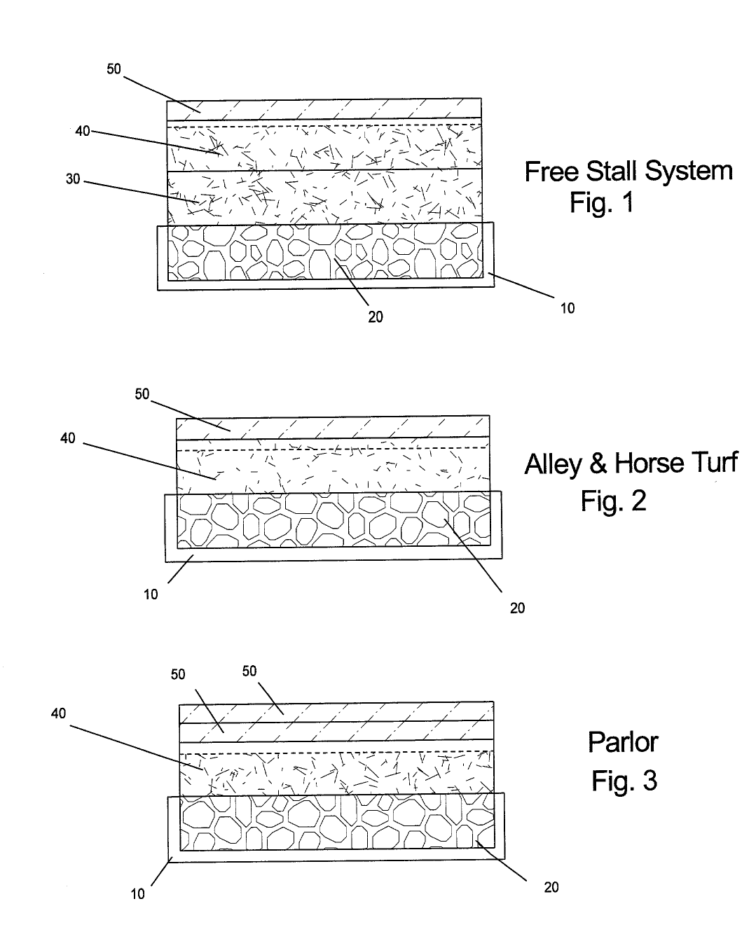

With reference then to FIGS. 1-3, each of the above defined areas are variably configurable as embodied by the present system and method.

Animal handling areas 10 are typically comprised of one or a combination of the following—asphalt, concrete, stone, sand, mulch, sawdust, composted manure, straw, wood chips, ground limestone, shredded newspaper, cornstalks, bark, peanut hulls, sunflower hulls, and rice hulls. Each animal handling area 10 must be modified to accommodate base 20 or be substituted by base 20.

Base 20 is a base material that may be concrete, asphalt, or a compacted, aggregate road base. Animal handling area 10 is excavated to allow for base 20 application and curing. If base material of base 20 is asphalt or concrete, it is preferred that a slope of at least ¼ inch per foot be maintained and that floor drains be located at the ends of the alleys or against low ends of walls or curbs. Floor drains should be located outside of required high impact areas as the drains and the drain caps will not be covered with flooring surface, unless otherwise specified. Weep holes are acceptable if 2″ by 3″ are installed in intervals of 3 feet at the low end of the slab, and if smaller, the weep holes need to be 2 feet apart in intervals. Base 20 of concrete or asphalt must also maintain a tolerance of ⅛ inch in ten (10) feet to avoid low areas that will hold water under the flooring surface rubber. The concrete is preferably finished with a light broom and, alternatively if used, the asphalt should be compacted properly using any type of acceptable equipment.

Base 20 of aggregate must meet necessary minimum requirements as is generally known in the art for transportation. A geotextile filter fabric/cloth must be installed between the top layer of aggregate and any rubber coating. A 304 Crushed Limestone or approved crushed road base material with fines, for example, is acceptable. Perimeter containment of aggregate is necessary to maintain proper stability and washout prevention. Base 20 of aggregate has a thickness of at least 4 inches, and the top coat of aggregate should be level and compact and contain aggregate of a size that eliminates voids, which could cause swelling of the rubber flooring. Drainage may be obtained directly by the porosity of the aggregate or by some other perforated cloth wrap or other approved system.

After animal handling area 10 has been modified or substituted by base 20, and base 20 has been finished and/or allowed to cure, rubber sub-coat 30 and rubber top coat 40 are prepared. It is preferred that a sub-coat 30 underlay the top coat 40 in the construction of the free stall to increase the degree of softness in this area whereon the animals spend a relatively longer period of time. Obviously, however, there may be more than one sub-coat 30 or top coat 40 applied where necessary in any location on top of base 20, though it may not be as economically efficient and cost-effective. Thus, at least one coating is applied over base 20, wherein the coating comprises a mixture of granulated rubber and urethane.

The granulated rubber may be any type of non-recycled or recycled styrene butadiene (SBR) rubber or EPDM granules ground at an ambient temperature. The SBR rubber is preferably ground into shredded strands with each strand ranging in length from ⅜″ to ⅝″ (though not required) yielding less than 4% dust at this range. The EPDM rubber is ground to contain granules preferably of length in the range of 1-5 mm though it may be more or less. At this range, the ground rubber composition will also contain less than 4% dust.

The urethane is preferably a high strength, polyurethane binder having a density at 20° C. of 1.09 g/cm³. The urethane preferably is an aromatic isocyanate prepolymer containing in part 70%-80% polymeric isocyanate. Depending upon which holding area is to be constructed, as will be seen by the following examples, the urethane is added to a weighed mixture of the rubber granules to form sub-coat 30 or top coat 40. Generally, the urethane is added to allow each coat to be 7% to 25% urethane, or 7 lbs-25 lbs urethane per 100 lbs of rubber. Curing takes place at ambient temperature by reaction with atmospheric moisture. Higher temperatures and moistures will shorten the curing time. Typically, after this mixture forms then at least one coating and is applied over base 20, the surface may be walked on after 12-18 hours at 20° C. Full curing is achieved after 3-5 days and the temperature must not fall below 10° C. during the curing process.

After the at least one coating has cured, and the surface is clean, dry, and free of oil, grease, dirt and any other foreign residue, at least one coating of a sealer 50 is prepared and applied over coating to seal the porous coating. Sealer 50 generally comprises a two-part mixture of part A and part B, wherein part A is an amine blend containing in part 10-20% diethyltoluene diamine (DETDA), and wherein part B is a cycloaromatic diisocyanate prepolymer containing in part less than 1% isophorene diisocyanate (IPDI). Each part of sealer is preferably that chemical composition sold under the Qualipur 5252HV brand name and as packaged in 5 gallon kits. Parts A and B are power mixed in the ratio of 1:6 respectively for at least five minutes. More than one sealer 50 may be applied for areas that must meet sanitation requirements, such as milking parlors. An additional sealer 50 application further provides for much smoother, non-porous, and slip-resistant surface, thereby providing an animal with the safest footing available.

Thus, the animal handling floor system generally comprises a base, at least one coating of a mixture of rubber and urethane covering said base, and at least one sealer applied over said coating. Approximate finished properties of the present animal handling floor system are shown below by the following table 1:

TABLE 1
Testing and Results

| | |
|---|---|
| Thermal Resistance | R = 2.32 |
| Compression Endurance | No deterioration |
| (10,000 cycled | |
| w/10 ton load) | |
| Flash Point | Between 650° and 800° F. |
| Accelerated weathering | No change |
| (2,500 hours) | |
| Water Aged | 1.61 - UV aged 1.92 pass |
| Coefficient of Friction | 1.0 Dry |
| (ASTM D2047-82) | 0.9 wet |
| Abrasion Resistance | 0.3812 G loss |
| (ASTM D1044) | |
| Elongation | 173% |
| Skid Resistance | 89 dry |
| (ASTM E303-93) | 57 wet |

### EXAMPLE 1

### Free Stall System

For sub-coat, course rubber material is hand loaded into a gas powered motor mixer 1-50 lb bag at a time. After two bags are in the mixture, a weighed bucket of urethane is added to make the mixture 7% to 18% urethane. The urethane may be brand name Qualipur 3500, from Advanced Polymer Technology, Harmony, Pa. for example though different suppliers may be used. This is allowed to mix for 60 seconds. After 60 seconds the mix is dumped into a wheelbarrow and applied at the required thickness by hand, using a screed board, and finished by hand trowel.

For top-coat, course rubber material is weighed 25 lbs at a time and added to a gas powered motor mixer until 100 lbs of rubber are in the mixer. A weighed bucket of urethane is then added, to make the mixture 15 lbs to 22 lbs urethane per 100 lbs rubber (15%-22%). This is allowed to mix for 60 seconds. After this time period, the mix is dumped into a wheelbarrow and applied at the required thickness by hand using a screed board, and then finished by hand trowel.

For sealer, two-part mixture of A and B (Qualipur 5252HV, Advanced Polymer Technology, Harmony, Pa. for example) are added together by weight ratio 1:6 respectively. Both are mixed with an electric drill and paddle attachment for five minutes and applied by hand trowel.

Completed three-layer system on top of base has typical ranges of:

| | |
|---|---|
| Sub-coat | 1″ to 4″ |
| Top-coat | ½″ to 1″ |
| Sealer Penetration | 3/16″ to ¼″ |

### EXAMPLE 2

### Alleys/Aisles/Horse Turf

For top-coat, course rubber material is weighed 25 lbs at a time until 100 lbs of rubber is in mixer. A weighed bucket of urethane is then added to make the mixture 15% to 25% urethane. This is mixed for one minute, then the mix is dumped into a wheel barrow and applied at the required thickness by hand, using a screed board, and finished by hand trowel.

For sealer, two-part mixture of A and B are added together by weight ratio 1:6 respectively. Both are mixed with an electric drill and paddle attachment for five minutes and applied by hand trowel.

Completed two-layer system on top of base has typical ranges of:

| | |
|---|---|
| Top-coat | ½″ to 3″ |
| Sealer Penetration | 3/16″ to ¼″ |

### EXAMPLE 3

### Milking Parlors

For top-coat, course rubber material is weighed 25 lbs at a time until 100 lbs of rubber is in mixer. A weighed bucket of urethane is then added to make the mixture 15%-25% urethane. This is mixed for one minute, then the mix is dumped into a wheel barrow and applied at the required thickness by hand, using a screed board, and finished by hand trowel.

For sealer, two-part mixture of A and B are added together by weight ratio 1:6 respectively. Both are mixed with an electric drill and paddle attachment for five minutes and applied by hand trowel. A second coat of sealer is then applied over this first coat of sealer.

Completed two-layer system coat on top of base with extra sealer has typical ranges of:

| | |
|---|---|
| Top-coat | ½″ to 3″ |
| (2) Sealer Penetration | 3/16″ to ¼″ |

I claim:

1. A seamless floor system in an animal handling area, comprising:
a base composition covering a surface of said animal handling area;
at least one coating mixture covering said base composition, wherein said coating mixture is a mixture of granulated rubber and urethane containing in part said urethane in the range of 7%-25%; and,
at least one sealer covering said coating mixture, wherein an alley, a stall, or a milking parlor is formed as part of said animal handling area.

2. The seamless floor system of claim 1, wherein said base composition is a material selected from the group consisting of concrete, asphalt, and aggregate.

3. The seamless floor system of claim 1, wherein said sealer is a two-part mixture of a part A and a part B, wherein part A is an amine blend containing in part 10-20% diethyltoluene diamine, and wherein part B is a cycloaromatic diisocyanate prepolymer containing in part less than 1% isophorene diisocyanate.

4. The seamless floor system of claim 3, wherein said part A and said part B are mixed in a ratio of 1 to 6 respectively.

5. A seamless floor system in an animal handling area, comprising:
a base composition covering a surface of said animal handling area;
at least one coating mixture of rubber and urethane covering said base composition;
at least one sealer covering said coating mixture, wherein said sealer is a two-part mixture of a part A and a part B, wherein part A is an amine blend containing in part 10-20% diethyltoluene diamine, and wherein part B is a cycloaromatic diisocyanate prepolymer containing in part less than 1% isophorene diisocyanate.

6. The seamless floor system of claim 5, wherein said base composition is a material selected from the group consisting of concrete, asphalt, and aggregate.

7. The seamless floor system of claim 5, wherein said coating mixture contains in part said urethane in the range of 7%-25%.

8. The seamless floor system of claim 5, wherein said part A and said part B are mixed in a ratio of 1 to 6 respectively.

9. A seamless floor system in an animal handling area, comprising:
a base composition covering a surface of said animal handling area;
at least one coating mixture of rubber and urethane covering said base composition, wherein said urethane is an aromatic isocyanate prepolymer containing in part 70%-80% polymeric isocyanate; and,
at least one sealer covering said coating mixture, wherein said sealer is a two-part mixture of a part A and a part B, wherein part A is an amine blend containing in part 10-20% diethyltoluene diamine, and wherein part B is a cycloaromatic diisocyanate prepolymer containing in part less than 1% isophorene diisocyanate.

10. The seamless floor system of claim 9, wherein said base composition is a material selected from the group consisting of concrete, asphalt, and aggregate.

11. The seamless floor system of claim 9, wherein said coating mixture contains said urethane in the range of 7%-25%.

12. The seamless floor system of claim 9, wherein said part A and said part B are mixed in a ratio of 1 to 6 respectively.

13. A method for forming a seamless floor system in an animal handling area, comprising the steps of:
modifying a surface of said animal handling to form a base;
covering said base with a coating mixture of rubber and urethane;
mixing a two-part mixture of an amine blend and a cycloaromatic diisocyante prepolymer, respectively in the ratio of 1 to 6 to form a sealer; and,
covering said coating mixture with said sealer, thereby forming a stall, an alley, or a milking parlor in said animal handling area.

14. The method of claim 13, wherein for the step of modifying said surface, said animal handling area is excavated.

15. The method of claim 13, wherein for the step of modifying said surface, said animal handling area is cleaned free of animal debris.
